(19) United States
(12) Patent Application Publication
(10) Pub. No.: US 2003/0019935 A1
(43) Pub. Date: Jan. 30, 2003

(54) System and method for requesting and retrieving contact information via an encoded business card

(76) Inventor: Thomas Christophar Giannulli, Seattle, WA (US)

Correspondence Address: THOMAS GIANNULLI, 2929 FIRST AVE #200, SEATTLE, WA, 98121, US

(21) Appl. No.: 09/879,626

(22) Filed: Jun. 14, 2001

(51) Int. Cl. G06K 7/10; G06K 9/22; G06K 19/06; G02B 26/10

(52) U.S. Cl. 235/462.25

(57) ABSTRACT

A system and method for requesting and retrieving contact information from an encoded business card comprises a business card having a unique serial number imprinted thereon; a card reader device such as bar code reader adapted to read an encoded unique serial number; and an electronic communication device or computer coupled to the reader for communication to a central repository of contact information. In operation the bar-code imprinted on the business card is read by the card reader device and is then transmitted to a central networked computer for retrieval of business and./or personal contact information associated with the bar-coded serial number.

### CROSS-REFERENCE TO RELATED APPLICATIONS

U.S. Patent Documents

| | | | |
|---|---|---|---|
| 4272327 | June 1981 | Logan | 283/1. |
| 4465926 | August 1984 | Apitz | 235/472. |
| 4654793 | March 1987 | Elrod | 364/401. |
| 4817136 | March 1989 | Rhoads | 379/357. |
| 4945218 | July 1990 | Talbott | 235/487. |
| 4945219 | July 1990 | Tanaka | 235/488. |
| 5,483,052 | Jan. 9, 1996 | Smith, III, et al. | 235/462.49 |

### STATEMENT REGARDING FEDERALLY SPONSORED RESEARCH OR DEVELOPMENT

None

### FIELD OF THE INVENTION

The present invention relates generally to a bar code reader and particularly to a system for reading, storing and using bar-encoded data from a coded business card.

### BACKGROUND OF THE INVENTION

When one attends a business meeting, convention or any business related gathering, it is common practice to exchange business cards with people one meets. At the end of such meetings, one would typically have a stack of such business cards from individuals with information on each individual such as name, title, affiliation, address, telephone number, facsimile number and some other information that each individual may choose to include. To keep track of the contacts made, one would input the data from the cards into a computer with the appropriate software.

Inputting is normally done manually through a keyboard, which is time consuming and prone to human errors. Inputting may also be accomplished via optical imaging and optical character recognition of the actual business card. This method is prone to scanning and interpretation errors and requires a sophisticated and relatively expensive device to image and recognize the printed characters and words. In addition, this scanned data is only as current as the printing date of the business card and often represents information that may not be accurate.

There is therefore a need for a system that can retrieve 100% accurate and up to date business card information and automatically enter this data into a host computer, via a simple and low cost device that can be attached to a cell phone, personal digital assistant, 2-way pager or personal computer. Such a system would create a novel solution that would thereby eliminate the above-mentioned problems. Prior art as listed above does not make use of remote and centralized data stores for accurate business card information. The prior art also teaches the use of two dimensional bar codes, requiring sophisticated and relatively expensive barcode reader hardware, designed to encode the entire data set and fails to mention the use of simple ID codes and remote data stores and networked retrieval of business card data.

### BRIEF SUMMARY OF THE INVENTION

As described in the background above, the invention solves several current problems and offers several unique solutions 1) automated input of business card data into a personal computer or computing device; 2) up-to-date and accurate business card data that can be modified and updated at any time following the printing of the actual business card; 3) low cost and simple technology requirements for the bar code input device, thus allowing cell phones, PDA's and PC's to scan business cards utilizing simple, small and affordable bar code scanners, creating a new and universal method for capturing and retrieving business card data electronically.

### OBJECTS AND SUMMARY OF THE INVENTION

It is an object of the present invention to provide a business card with a unique bar-coded serial number or identification code.

It is another object of the present invention to provide a system for electronically requesting and retrieving business card data based on the imprinted bar-code serial number.

It is another object of the present invention to provide a method for electronically requesting and retrieving business card data based on the imprinted bar-code serial number.

In summary, the present invention provides a system and method for requesting and retrieving 100% accurate and timely electronic business card data from a coded business card such that manual inputting of the information is eliminated. These and other objects of the present invention will become apparent from the following detailed description.

### BRIEF DESCRIPTIONS OF THE DRAWINGS

FIG. 1 shows a business card with bar-encoded serial number in accordance with the present invention.

FIG. 2 is a perspective diagram of a system for requesting and retrieving electronic business card data as a result of bar-code reading the business card of FIG. 1.

### DETAILED DESCRIPTION OF THE INVENTION

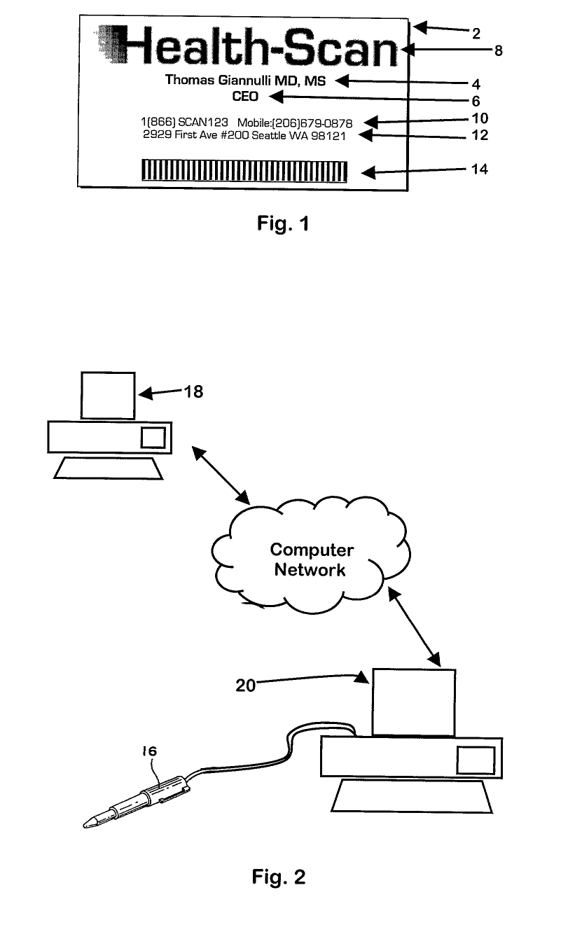

A business card 2 printed in accordance with the present invention is disclosed in FIG. 1. The card 2 has several imprinted information pertaining to the card owner's name 4, title 6, affiliation or company name 8, address 10 and telephone numbers 12. In addition a bar code 14 on the face of the business card 2. The bar code 14 is a one-dimensional bar code. The standard one-dimensional bar code can only hold up to 5 or 10 characters per inch, making it unsuitable for encoding all the information typically found on a business card. In contrast, encoding all the information on the business card 2 using a two-dimensional bar code would require substantially more sophisticated and expensive bar code reader technology, and would only represent the information current at the time of printing. The bar code in this invention represents a unique identification code linked the card's subject which requires remote retrieval of all business card data stored in a remote database. This system can therefore utilize a simple bar-code reader and always reflect the most current information about the subject.

The bar code 14 is scanned by a light pen or scanner/reader 16, which in turn is coupled to a computer 20 configured to receive, manipulate and transmit the data contained in the bar code 14, to the remote computer 18, as best shown in FIG. 2. The computer includes an application software to enable the communication of the bar code data to a central remote computer located across a computer network. The software can also receive messages from the remote computer which contain the business card data 8,10,12 that corresponds to the business cared 2. This data can then be inserted by the software into the users preferred contact management software system on their personal computer or communication device. The computer 20 is a standard personal computer, such as an IBM-Compatible computer, though may represent a personal digital assistant, digital cellular phone, two way pager device or other mobile communication and computing device.

The data on the business card 2 may also be encoded on a magnetic strip, in which case a magnetic reader would be used.

Although the present invention has been illustrated using a business card, it should be apparent that the present invention is equally applicable to any printed materials, such as marketing or product literature, etc. with bar-encoded data.

While this invention has been described as having preferred design, it is understood that it is capable of further modification, uses and/or adaptations following in general the principle of the invention and including such departures from the present disclosure as come within known or customary practice in the art to which the invention pertains, and as may be applied to the essential features set forth, and fall within the scope of the invention or the limits of the appended claims.

We claim:

1. A system for requesting and retrieving contact information by means of a unique identification code from a business card, comprising:
a) a business card having printed business data and a unique identification bar-code
b) a card reader device adapted to read said identification bar-code, and convert to a digital code or analog signal;
c) a computer and or communication device coupled to said reader for communicating said signal or code to a remote computer system through standard networking protocols, such as TCP/IP;
d) a remote computer system that stores electronic business card data indexed by unique digital code;
e) a remote computer system that can retrieve electronic business card data when queried by a unique digital code
f) a remote computer system that can transmit retrieved electronic business card data to other computers or communication devices through standard networking protocols;

2. A system as in claim 1, wherein the imprinted bar code may be detected via optical or magnetic sensing means

3. A system as in claim 1, wherein:
a) said business card data includes at least a person's name and address.

4. A method for electronically requesting and receiving business card data, comprising the steps of:
a) acquiring a digital identification code from a business card through the use of a bar code reader;
b) uploading said digital identification code from said bar-code reader to a remote networked computer which contains a database of electronic business card data;
c) downloading the electronic business card data associated with said digital identification code, to a remote computer or communication device.
